(19) United States
(12) Patent Application Publication
(10) Pub. No.: US 2026/0200111 A1
(43) Pub. Date: Jul. 16, 2026

(54) Drive Unit for Hair Trimmer and Hair Trimmer

(71) Applicant: Zhejiang Yasun Intelligent Technology Co., Ltd., Jiaxing (CN)

(72) Inventors: Lixu Yu, Jiaxing (CN); Jian Yao, Jiaxing (CN)

(21) Appl. No.: 19/436,210

(22) Filed: Dec. 30, 2025

(30) Foreign Application Priority Data
Jan. 14, 2025 (CN) 202510055869.4
Dec. 1, 2025 (CN) 202511786623.0

(51) Int. Cl. B26B 19/28; B26B 19/02

(52) U.S. Cl. CPC B26B 19/28; B26B 19/02

(57) ABSTRACT

A drive unit for a hair trimmer and a hair trimmer, the hair trimmer includes a base component, a drive unit, and a blade component. The drive unit includes a base, a cover plate, a flexible plate, limit pins, movable plates, and a drive block. The cover plate has fixing posts, and mounting holes. The movable plates are assembled on the limit pins. Two ends of each of the movable plates have a positioning groove. Each of the positioning grooves is being flexibly inserted into the limit grooves of the limit pins. In a direction perpendicular to a central axis of the limit grooves a contact between a side wall of the positioning grooves and a side wall of the limit grooves is line contact. It not only improves product yield and reduces costs, but also lowers the output power of the drive mechanism, thereby extending battery life.

### RELATED APPLICATION

This present application claims benefit of the CN application, CN202510055869.4, filed on Jan. 14, 2025 and CN application, CN202511786623.0, filed on Dec. 1, 2025, the specifications of which are incorporated in their entirety by reference.

### BACKGROUND

### Technical Field

The present invention relates to hair trimming equipment, and more particularly to a drive unit for a hair trimming and a hair trimmer.

### Description of Related Art

A razor or a hair trimmer is an electric grooming device that uses blades to trim facial hair and sideburns, which is primarily divided into two types: rotary and reciprocating. Rotary razors operate through central rotation, making continuous circular motions for smooth shaving with minimal noise. Reciprocating razors, on the other hand, use a back-and-forth blade movement that generates more vibration and noise, with stronger shaving power.

An electric shaver includes a mesh cover made of stainless steel, inner blades, a miniature motor, and a housing. The mesh cover serves as the fixed outer blade with numerous holes for beard strands to enter. The miniature motor, powered by electricity, drives the inner blades to cut the beard strands through the shearing principle. In prior art, a reciprocating electric shaver disclosed in Chinese Patent Application CN202210092634.9, which includes a blade component, a motor, and a drive mechanism that drives the inner blade for reciprocating motion. The blade component includes an outer blade and an inner blade sliding along its inner surface. A power conversion mechanism is disposed between the drive mechanism and the motor and is used to transforms rotational force into reciprocating motion. The power conversion mechanism includes an eccentric wheel mounted on an output shaft of the motor, and a driver directly or indirectly connected to the drive mechanism. The output shaft is an eccentric shaft. The driver is made of elastic material and has a matching groove opened thereon. The matching groove and the eccentric shaft interference fit and the damping between two side walls of the matching groove and the eccentric shaft exceeds the frictional damping between the inner and outer blades of the blade component so as to achieve the transformation of power into reciprocating power to drive the blade component.

However, the eccentric shaft is directly connected to the inner blade of the blade component in prior art. As a result, unstable connections are formed. Additionally, the eccentric shaft can only drive one blade component to reciprocate and it is difficult to achieve staggered movement of multiple cutting blades.

To resolve the aforementioned technical challenges, prior art provides a technology, such as Patent Application No.202410140737.7. The technology discloses a transmission unit mounted on two guide shafts and reciprocates along the two guide shafts when driven. As well known, noise control is critical for hair cutting or shaving tools operating near user ears, with national standards mandating noise levels below 75 decibels. To achieve this, the clearance between the guide shafts and their corresponding holes on the transmission unit must be minimized, which is typically under 0.02mm. If the clearance is greater than 0.02mm, vibration will occur, and the noise generated by this vibration will be greater than 75 decibels. Meanwhile, the dual-shaft configuration is essential as a single shaft would fail to define a plane in which the transmission unit works. Under this premise, many technical problems will arise. First, the coaxiality error between the guide shafts must be kept below 0.2 due to their surface-contact design, otherwise unacceptable noise will be generated. Second, the straightness error of the two holes must also be controlled within 0.02. If the error is greater than 0.02, it can result in noise exceeding the 75dB threshold. Third, the surface roughness requirements for the guide shaft and the hole are extremely stringent. Even slight unevenness or particles in the 0.02mm clearance could prevent the guide shafts from moving. However, it is difficult to guarantee the surface roughness of the hole, and even if it can be guaranteed, its manufacturing cost will significantly increase. Fourth, the guide shaft must achieve exceptional straightness. Even minor curvature could jam the guide shaft, rendering it immobile. Fifth, the extremely narrow clearance becomes even tighter under manufacturing tolerances. This creates a critical issue: during summer, thermal expansion differences between metal and plastic components may cause jamming, while in winter, increased clearance leads to noise. Sixth, these combined precision requirements often result in trade-offs during production, making the system prone to jamming or locking. This not only hampers yield improvement but also keeps costs high all the time. Moreover, due to the above shortcomings, the output power of the driving motor is larger, because the cooperation between the manufactured transmission unit and the guide shaft is very tight, and a large force is needed to drive the transmission unit to slide on the guide shaft, which will further increase the noise and power consumption of the motor and reduce the service time of the battery after each charge.

Therefore, it is necessary to provide a drive unit for a hair trimmer and a hair trimmer which makes it possible to resolve the above problems.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout two views.

FIG. 1 is an exploded schematic view of a drive unit for a hair trimmer according to a first embodiment of the present invention.

FIG. 2 is an exploded schematic view of the drive unit of FIG. 1, viewed from different perspectives.

FIG. 3 is a cross-sectional schematic view of the the drive unit of FIG. 1.

FIG. 4 is a schematic view of a hair trimmer according to a second embodiment of the present invention.

FIG. 5 is an exploded schematic view of the hair trimmer of FIG. 4.

FIG. 6 is a schematic view of a drive unit of the hair trimmer of FIG. 4.

FIG. 7 is an exploded schematic view of the driver unit of FIG. 6.

FIG. 8 is a schematic view of the drive unit of FIG. 6, viewed from different perspectives

FIG. 9 is a schematic view of the drive unit of FIG. 6 without a base.

FIG. 10 is an exploded schematic view of a blade component of the hair trimmer of FIG. 4.

### DETAILED DESCRIPTION

The present application is illustrated by way of example and not by way of limitation in the figures of the accompanying drawings. It should be noted that references to “an” or “one” embodiment in this application are not necessarily to the same embodiment, and such references mean at least one.

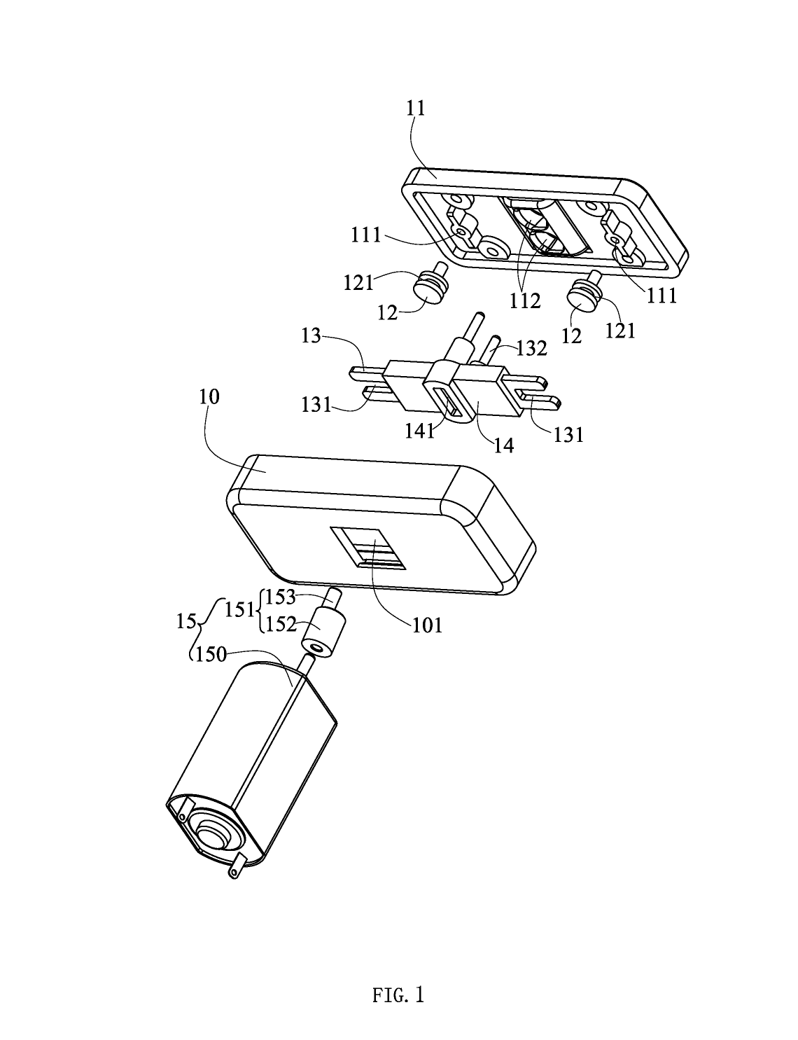

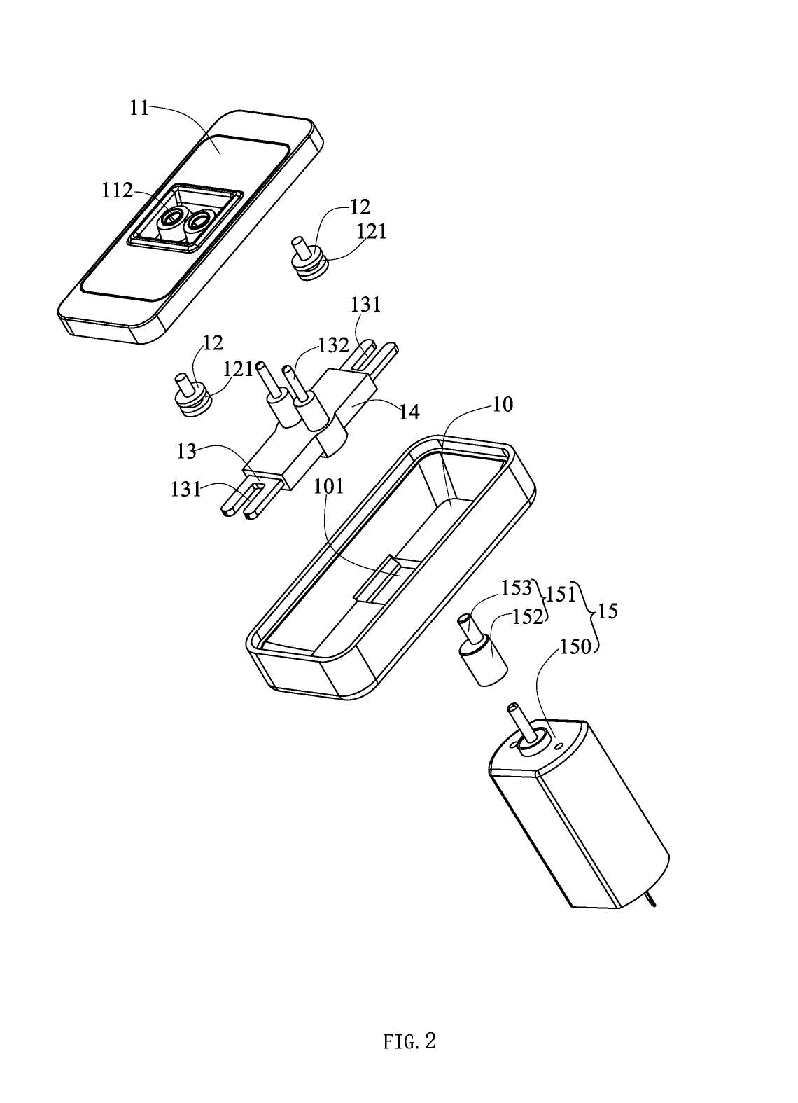

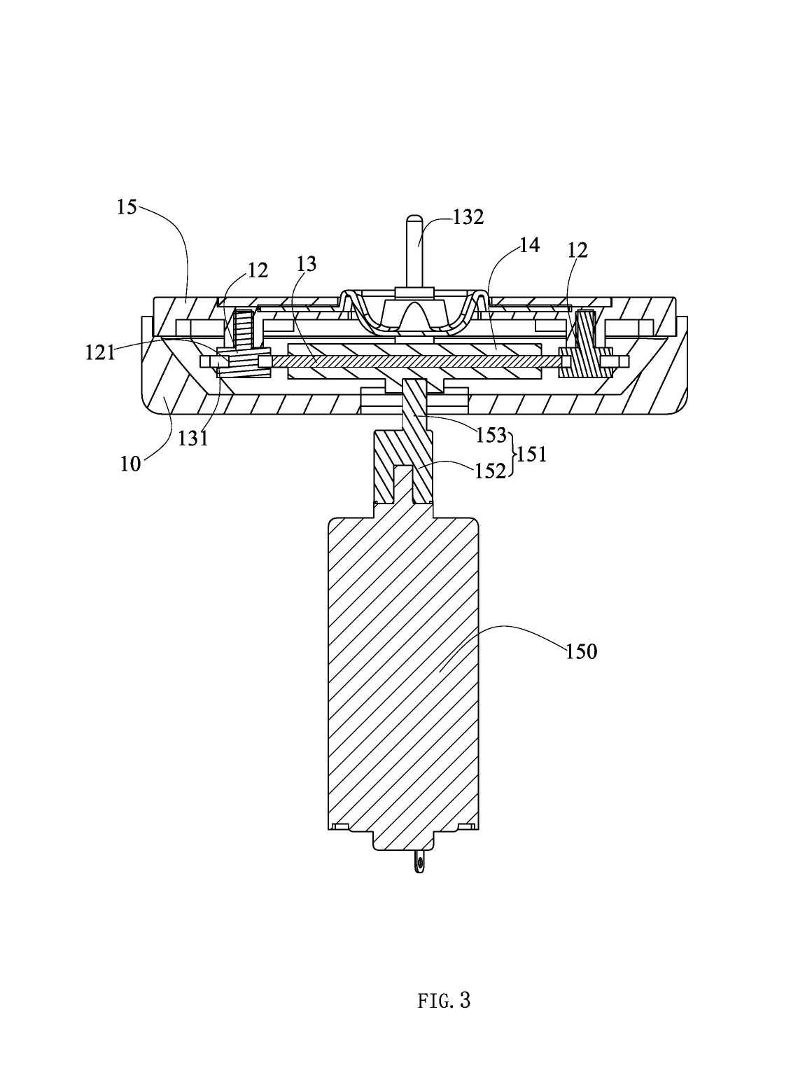

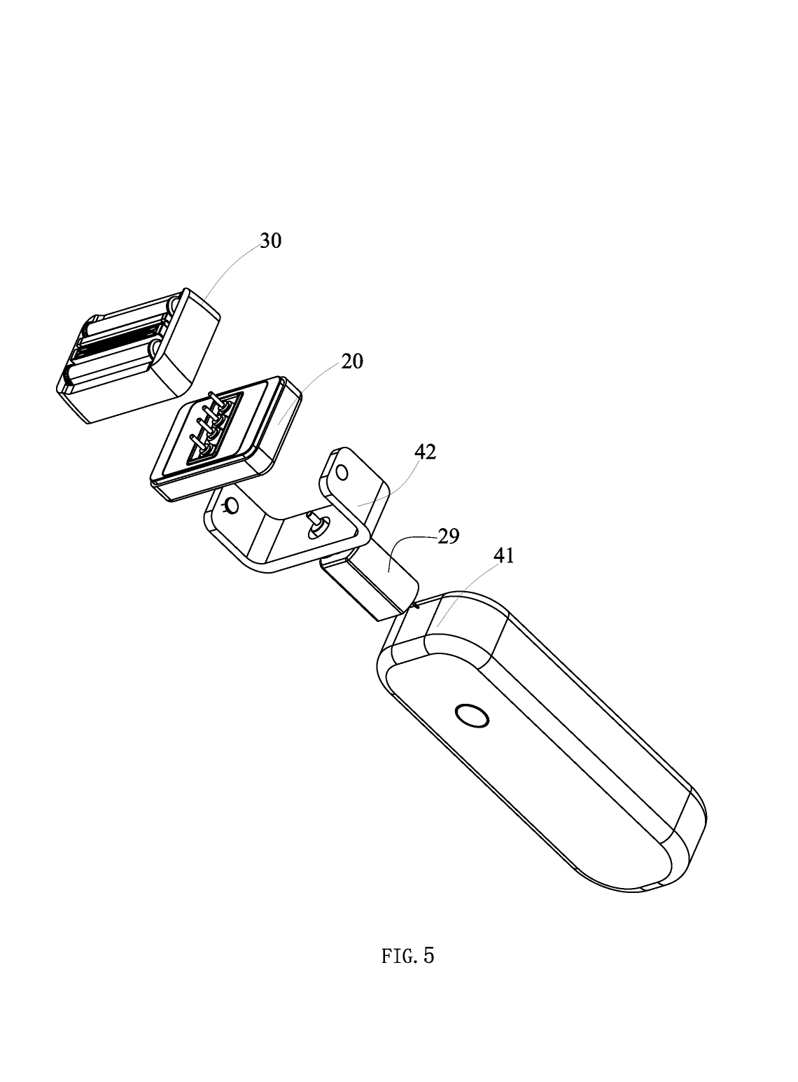

Referring to FIG. 1 to FIG. 5, a drive unit for a hair trimmer is shown in accordance with a first embodiment of the present invention. The drive unit includes a base 10, a cover plate 11 mounted on the base 10, at least one pair of limit pins 12 spaced apart each other and disposed on the cover plate 11, at least one movable plate 13 slidably engaged with the limit pins 12, at least one drive block 14 mounted on the movable plate 13, and a drive mechanism 15 for driving the drive block 14. It should be understandable that the drive unit may further include other functional modules such as a power supply, and mounting components, which are well known to those skilled in the art and are not detailed here one by one.

The base 10 is configured for supporting or accommodating various components, such as the cover plate 11 and the movable plate 13. The base 10 is therefore configured for easy installation or assembly of these components, which will not be described in detailed. In this embodiment, a bottom of the base 10 has a groove-shaped configures and has a through-hole 101 for inserting an input end of the drive mechanism 15.

The cover plate 11 covers on the base 10 and at least one pair of mounting holes 111 and at least one through hole 112 are opened on a side wall thereof which faces the movable plate 13. The mounting holes 111 are configured to securely dispose the limit pins 12. It can be understood that when it has two or more pairs of the limit pins 12, the mounting holes 111 should correspondingly have two or more pairs, as detailed in a second embodiment. The through holes 112 are used to accommodate a drive rod 132 of the movable plate 13, which will be described in detail below.

The limit pins 12 has at least one pair or two pairs and the two limit pins 12 are spaced apart each other and fixed within the mounting holes 111. In the first embodiment, the limit pins 12 has a pair. A limit groove 121 is opened on each of the limit pins 12, and the limit groove 121 may be annular. The limit pins 12 are made of metal and a dimensional accuracy of the limit groove 121 can be achieved through machining. That is to say, a dimensional accuracy of the limit groove 121 along radial and axial thereof can be achieved through machining. The specific dimensional accuracy of the limit groove 121 will be described in conjunction with the movable plate 13.

The movable plate 13 is also made of metal to ensure machining precision. Two ends of the movable plate 13 are respectively provided with a positioning groove 131, that is to say, one movable plate 13 has two positioning grooves 131. The two positioning grooves 131 of the movable plate 13 are respectively inserted into the positioning grooves 121 of the two limit pins 12.

The positioning groove 131 may be a square groove so as that the contact between the positioning groove 131 and a side wall of the limit groove 121 is line contact. It can be understood that the positioning groove 131 can have other shape, but it is necessary to ensure that the contact between the positioning groove 131 and the side wall of the limit groove 121 is line contact. Because the contact between the positioning groove 131 and the side wall of the limit groove 121 is line contact, the control of its accuracy is much less difficult than that of the surface contact in the prior art. Moreover, both the positioning groove 131 and the limit groove 121 can be machined, and their accuracy is also very easy to achieve, so that the clearance accuracy between the positioning groove 131 and the limit groove 121 can be easily controlled below 0.02 mm.

Although the movable plate 13 is in surface contact with the positioning groove 121 along a thickness direction of the positioning groove 121, the thickness of the movable plate 13 and the width of the positioning groove 121 can be easily controlled below 0.02mm through machining. Therefore, the clearance between the movable plate 13 and the positioning groove 121 along the thickness direction of the positioning groove 121 can also be easily achieved below 0.02mm. It is well known that precision control is common knowledge among machining technicians in this field.

When both of the positioning grooves 131 are inserted between the two limit grooves 121, since the limit groove 121 is annular and the contact between the positioning groove 131 and the limit groove 121 is line contact, there is no accuracy requirement for a position tolerance of the two positioning grooves 131 and the arrangement direction of the central axes of the two limit pins 12. That is to say, the arrangement direction of two positioning grooves 131 may be parallel to that of the central axis of two limit pins 12 or has a small angular deviation caused by manufacturing errors. Therefore, since the contact between the positioning groove 131 and the limit groove 121 is line contact, even there is the small angular deviation, the movable plate 13 will not be locked and the movable plate 13 can rotate by a small angle. Therefore, the small angular deviation does not cause the drive unit to malfunction (e.g., jamming or locking) and the drive unit is unaffected by thermal expansion and cold contraction.

As described above, the precision control between the movable plate 13 and limit pins 12 depends on only two factors. One is the clearance precision between the positioning groove 131 and the side walls of the limit groove 121, and the other is the clearance precision between the movable plate 13 and the limit groove 121 along the central axes of the limit pins 12. Furthermore, the two clearance precision are independent of each other, which making precision control straightforward. It not only improves product yield and reduces costs, but also lowers the output power of the drive mechanism 15 due to minimal sliding resistance, thereby extending battery life.

The movable plate 13 is equipped with at least one drive rod 132 on its side facing the cover plate 11. In the first embodiment, two drive rods 132 are installed. The drive rods 132 pass through the through hole 112 to connect with the blade component (not shown) so as to enable the blade component to operate during the reciprocating motion of the movable plate 13 for shaving.

The drive block 14 is fixedly mounted on the movable plate 13. A strip-shaped slot 141 is opened on a side of the drive block 14 facing the drive mechanism 15. An extending direction of the strip-shaped slot 141 is perpendicular to the moving direction of the movable plate 13, that is, perpendicular to the arrangement direction of the two positioning grooves 131. When an eccentric section 153 of an eccentric shaft 151 of the driving mechanism 15 is inserted into the strip-shaped slot 141, the moving distance of the output shaft 151 in a direction perpendicular to the moving direction of the movable plate 13 is eliminated by the strip groove 141, so that only the driving block 14 is driven to reciprocate along the moving direction of the movable plate 13. The driving block 14 is usually made of plastic, which can be directly injected with the movable plate 13 by injection molding process, so that the movable plate 13 is fixed in the driving block 14 together.

The drive mechanism 15 may be a motor 150 and the eccentric shaft 151 is disposed at an output end of the motor 150. The eccentric shaft 151 includes a central shaft section 152 and the eccentric section 153 connected to the central shaft section 152. The central shaft section 152 of the eccentric shaft 151 is coaxially aligned with the output end of the motor150 and the eccentric section 153 is offset from the central shaft section 152 so as to form an eccentric wheel. The eccentric section 153 is inserted into the strip-shaped slot 141. When the motor 150 rotate the eccentric shaft 151 and the eccentric section 153 of the eccentric shaft 151 will make a circular motion so as to drive the movable plate 13 to reciprocate. The reciprocating motion of the movable plate 13 drives the blade head (not shown) to move back and forth, achieving the shaving function.

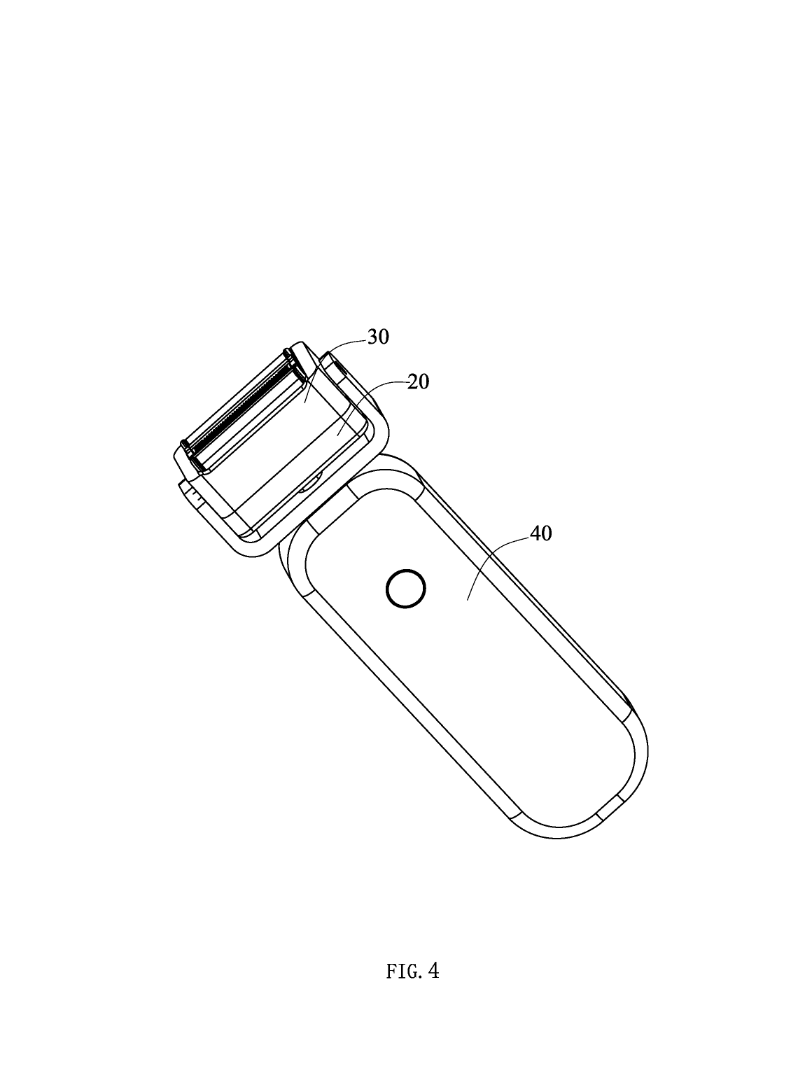

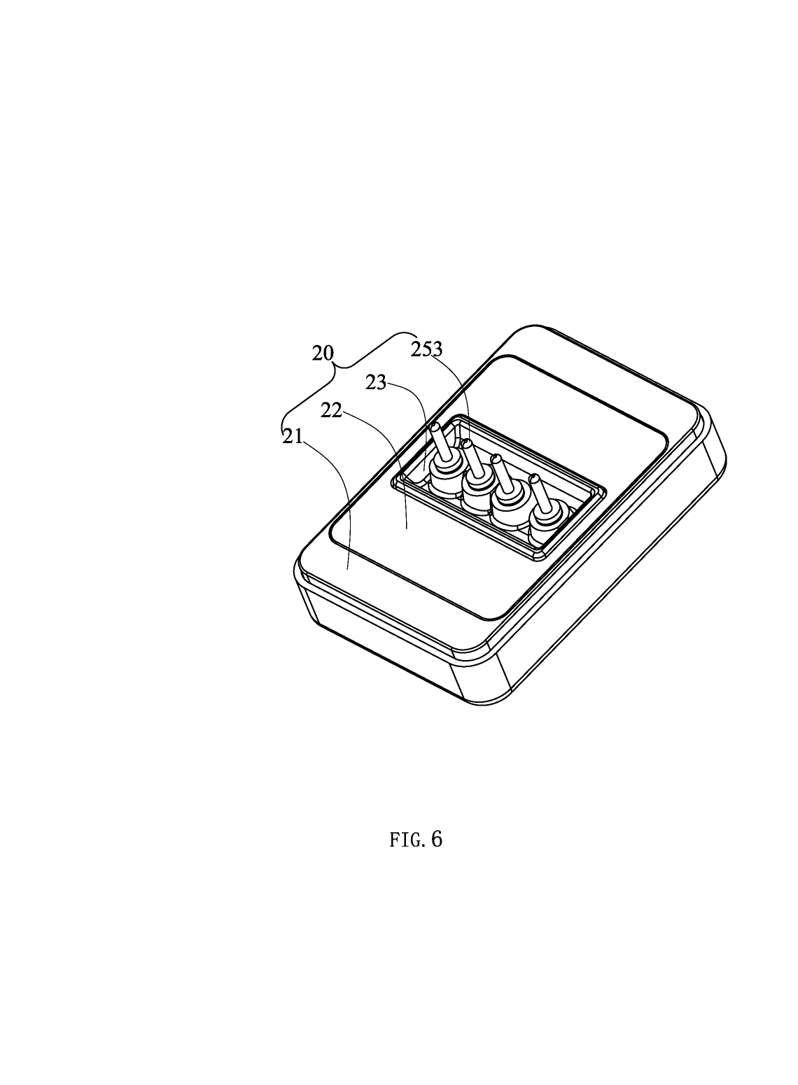

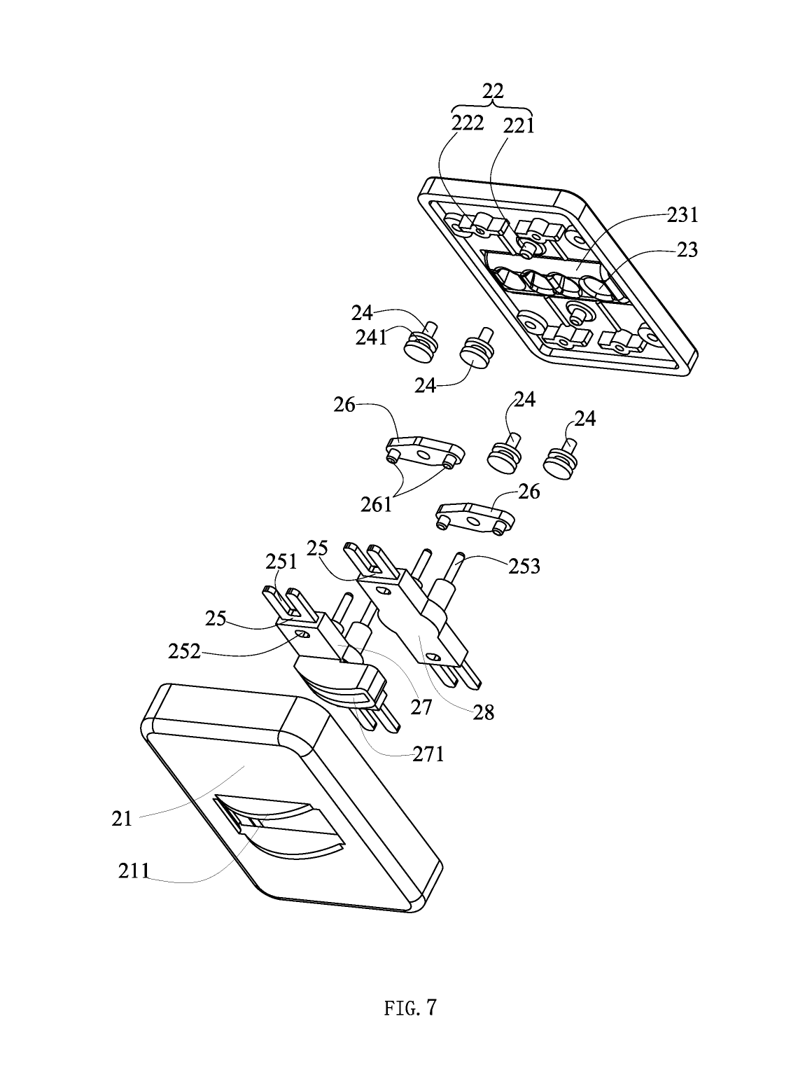

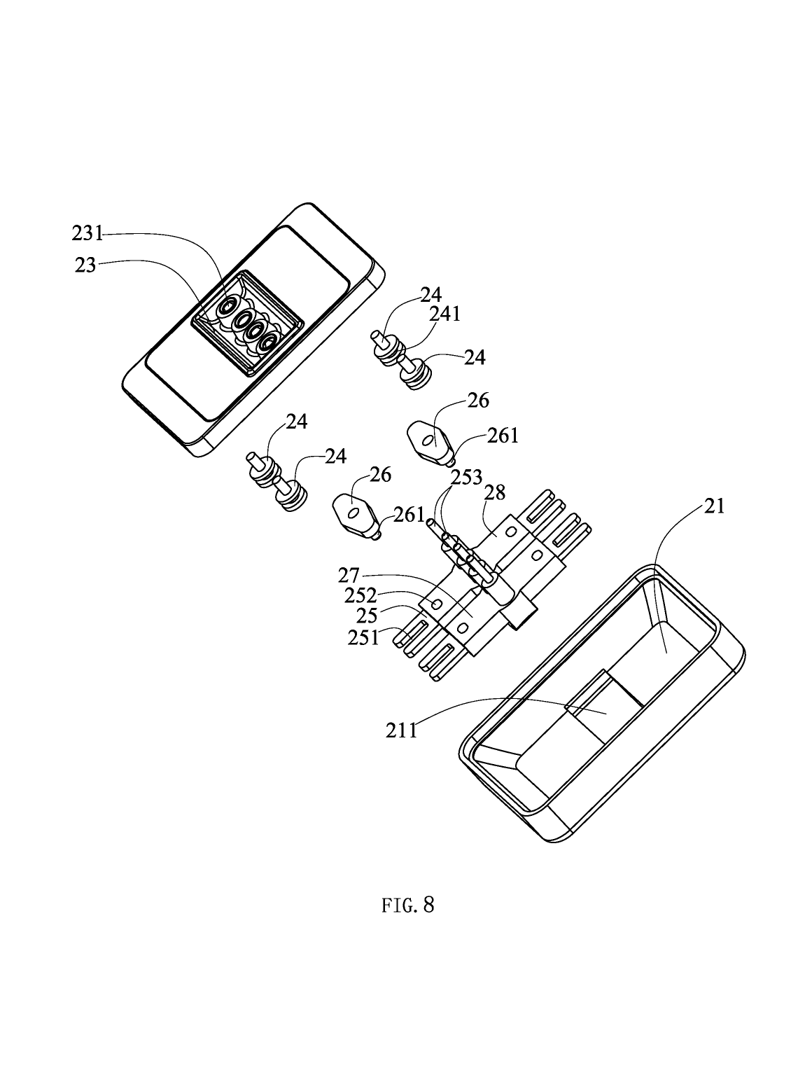

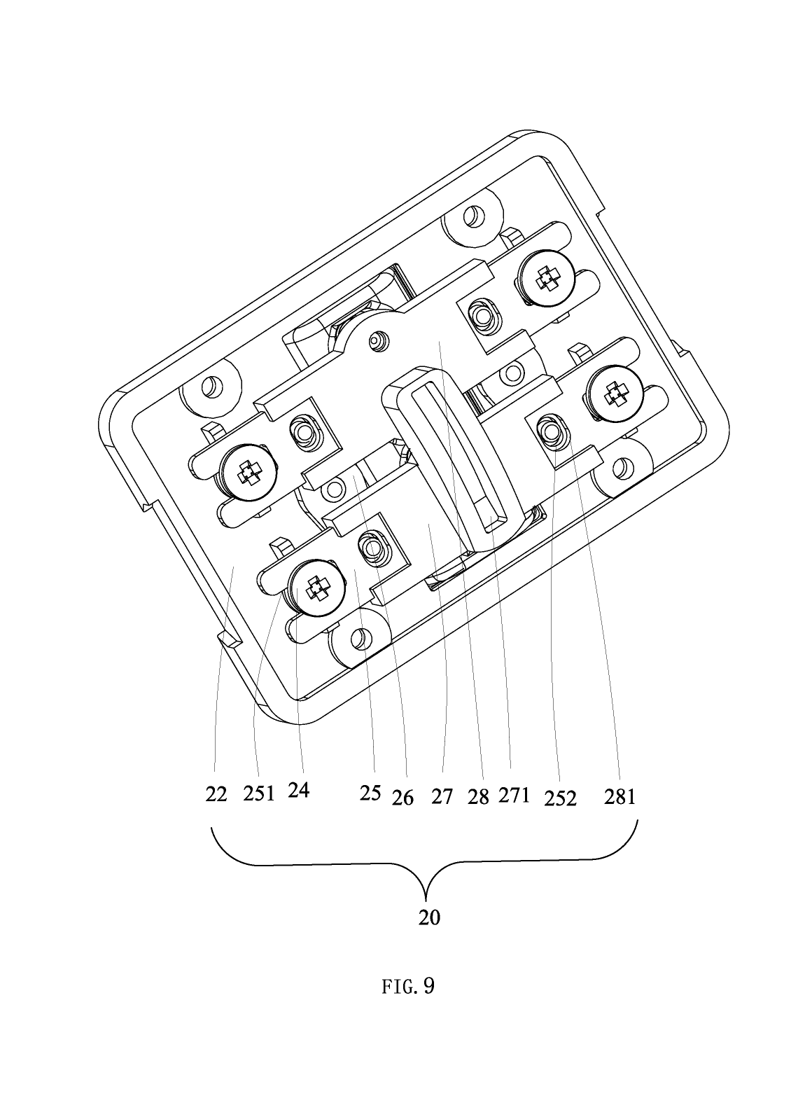

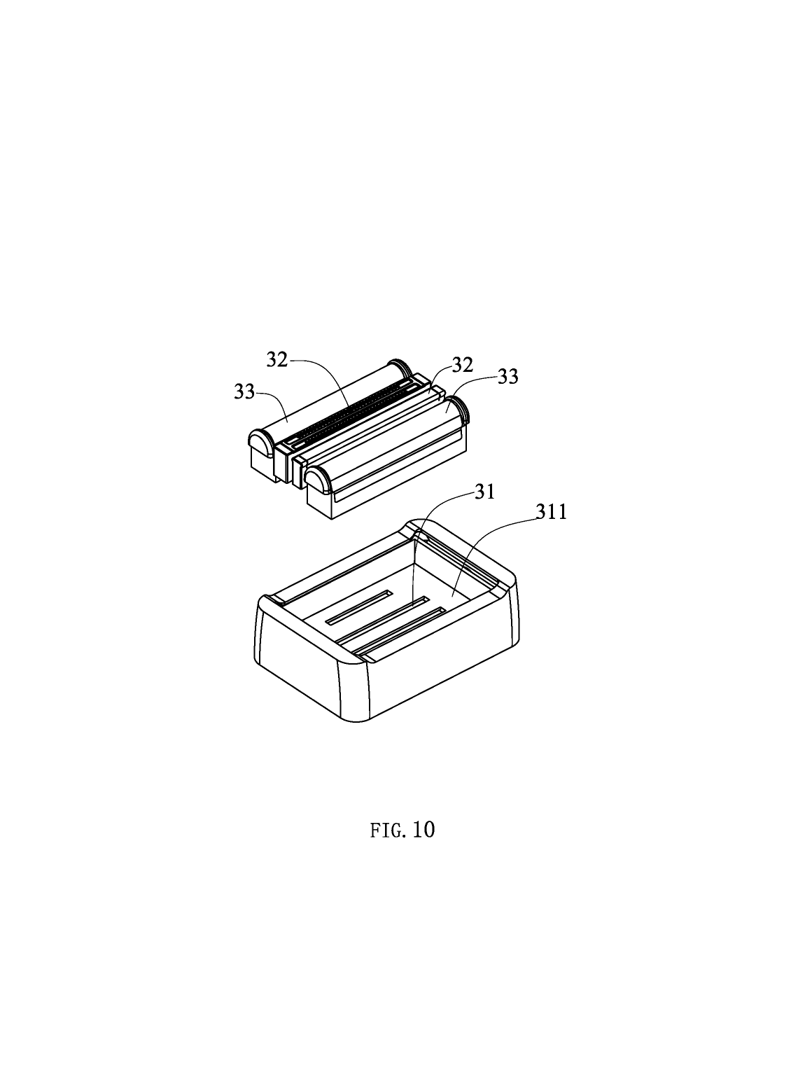

Referring to FIG. 4 to FIG. 10, a hair trimmer with the drive unit is illustrated in a second embodiment of the present invention. The hair trimmer includes a base component 40, a drive unit 20 mounted on the base 40, and a blade component 30 attached to the drive unit 20. It should be noted that the hair trimmer may also have additional functional modules such as assembly components, electrical connection components, and battery components, which are well known to those skilled in the art.

The base component 40 includes a handle 41 and a mounting base 42 mounted on the handle 41.

The handle 41 is used to assemble the above-mentioned functional modules. The handle 41 is equipped with various functional structures, such as screws and bolts, to facilitate the installation and assembly of the functional modules. The functional structures can be configured according to practical needs, and will not be detailed here one by one.

The mounting base 42 is fixed on the handle 41 and is configured to mount the drive unit 20. Therefore, structure and shape of the mounting base 42 are based on the ability to install the drive unit 20, which will not be repeated here.

The drive unit 20 includes a base 21 attached to the mounting base 42, a cover plate 22 mounted on the base 21, a flexible plate 23 installed on the cover plate 22, at least two pairs of limit pins 24 mounted on the cover plate 22, at least two movable plates 25 disposed on the cover plate 22, at least two rotating plates 26 mounted on the cover plate 22, a drive block 27 disposed on one of the movable plate 25, a driven block 28 mounted on the remaining movable plates 25, and at least one drive mechanism 29 for driving the drive block 27.

The base 21 is rotatably or fixedly connected to both ends of the mounting base 42. When configured for rotation, the drive unit 20 and the blade component 30 arranged on the drive unit 20 can be rotated according to the attachment position of the hair trimmer, so as to ensure that the blade component 30 can be closely attached to the skin and ensure that no corner is missed during shaving. A bottom of the base 21 is provided with an opening 211, and the opening 211 is used for passing through the drive block 27.

The cover plate 22 shares the same structure as the cover plate 11 in the first embodiment, and has addition of two through holes for passing through drive rods 253. A side wall of the cover plate 22 facing the base 21 has at least two fixing posts 221 for rotatably mounting the rotating plate 26, and at least four mounting holes 222 for disposing the limit pins 24. The fixing posts 221 are configured for assembling the rotating plate 26 and the rotating plate 26 can rotate around the fixing posts 221, as will be detailed later together with the rotating plate 26. The mounting holes 222 are designed to securely fasten the limit pins 24 and the limit pins 24 are respectively fixedly inserted into the mounting holes 222 respectively.

The flexible plate 23 is mounted on the cover plate 22 and has at least two aligned perforations 231. The perforations 231 are used to penetrate the driving rods 253 of the movable plate 25. The flexible plate 23 is made of flexible material, so that the movement of the driving rods 253 will not be affected, and the flexible plate 23 can seal the gap between the driving rods 253 and the cover plate 22, so as to prevent beard residue from falling into the drive unit 20 and prevent the normal operation of the transmission from being affected.

The number of the limit pins 24 is determined by the number of movable plates 25. In the second embodiment, since there are two movable plates 25, there are four limit pins 24. Each of the limit pins 24 has a circular limit groove 241 opened thereon, and the limit groove 241 may be annular. The four limit pins 24 are arranged in a rectangular pattern and securely inserted into the mounting holes 222. The limit pins 24 are made of metal and the manufacturing accuracy of the limit pins 24 can be achieved by machining, such as the diameter and width of the limit groove 241. The specific dimensional accuracy of the limit groove 241 will be explained in conjunction with the movable plates 25.

The two movable plates 25 are arranged side by side and an alignment direction of the two movable plates 25 is parallel to that of the multiple perforations 231. The two movable plates 25 have the same structure and each of the movable plates 25 is also made of metal, so that its accuracy can be achieved by machining. Two ends of each of the movable plates 25 are respectively provided with a positioning groove 251. That is to say, each of the movable plates 25 has two positioning grooves 251. Therefore, the two positioning grooves 251 are respectively inserted into the limit grooves 241 of the two limit pins 24.

The positioning groove 251 may be designed as a square groove to ensure that the contact between the positioning groove 251 and a side wall of the limit groove 241 is line contact. The line contact between the positioning groove 251 and the side wall of the limit groove 241 significantly simplifies precision control compared to surface contact in the prior art. Both the positioning groove 251 and the limit groove 241 can be machined and the manufacturing accuracy can be easily achieved. As a result, the clearance accuracy between the positioning groove 251 and the side wall of the limit groove 241 can be maintained below 0.02mm.

Although the movable plate 25 is in surface contact with the limit groove 241 in a thickness direction of the movable plate 25, the thickness of the movable plate 25 and the width of the limit groove 241 can be easily maintained below 0.02mm by machining, so the clearance accuracy between the movable plate 25 and the limit groove 241 in the thickness direction can also be easily maintained below 0.02mm.

When both of the positioning grooves 251 are inserted between the two limit grooves 241, as the line contact between the limit grooves 241 and the positioning grooves 251 eliminates precision requirements for the alignment direction of the center axes of the two limit posts 24 mounted on one of the movable plate 25 relative to that of the center axes of the other two limit posts 24 mounted on the other movable plate 25. That is to say, in the moving direction of the movable plate 25, the arrangement direction of the central axes of two of the four limit pins 24 may be parallel to that of the central axes of the other two of the four limit pins 24, or may have a small angular deviation caused by manufacturing errors. That is to say, even if there is a small angle, it will not block any of the movable plates 25 from moving as the contact between the positioning groove 251 and the limit groove 241 is line contact and the movable plate 25 can rotate by a small angle. The small rotate angle will not cause the blade component 30 to be unable to work, such as jamming or locking, but it is only possible to deform two parallel blades of the blade component 30 into a scissors-like blade, which will not have any influence on hair cutting or beard shaving.

As described above, the precision control between the movable plates 25 and the limit pins 24 depends on only two factors. One is the clearance precision between the positioning groove 251 and the side wall of the limit groove 241, and the other is the clearance precision between the movable plate 25 and the limit groove 241 along the central axes of the limit pins 12. Furthermore, the two clearance precision are independent of each other, which making precision control straightforward. It not only improves product yield and reduces costs, but also lowers the output power of the drive mechanism 150 due to minimal sliding resistance, thereby extending battery life.

A moving direction of the movable plates 25 is perpendicular to an alignment direction of multiple perforations 231. Each of the movable plate 25 has two first oblong holes 252 respectively opened at both ends thereof. Each of the first oblong hole 252 is positioned between the positioning groove 251 and the center of the movable plate 25. The first oblong hole 252 is designed to accommodate a connecting shaft 261 of the rotating plate 26, and the specific description will be done in detail below in conjunction with the connecting shaft 261.

Each of the movable plates 25 is equipped with at least one driving rod 253. In the second embodiment, two driving rods 253 are installed on each of the movable plates 25 to drive a first cutting mechanism 32 and a second cutting mechanism 33 of the blade component 30 to move in opposite directions. The driving rods 253 are arranged in pairs on the movable plates 25 and free ends of the driving rods 253 pass through the perforations 231 in the flexible plate 23 and insert into the blade component 30. The two movable plates 25 drive the driving rods 253 to move, which in turn causes two moving blades of the blade component 30 to moving reciprocally. The specific mechanism will be explained in detail below in conjunction with the blade component 30.

The two rotating plates 26 share identical structural configurations, and each of the rotating plates 26 is rotatably arranged on the fixing posts 221. Two ends of each of the rotating plates 26 are respectively provided with the connecting shaft 261. The connecting shafts 261 are respectively inserted into one of the first oblong holes 252 of the two movable plates 25.

When one of the movable plates 25 moves back and forth, it drives one end of the rotating plate 26 to make a circular arc motion, thereby causing the other end of the rotating plate 26 to make a circular arc motion in the opposite direction, which in turn drives the other movable plate 25 to move back and forth, thus achieving the reciprocating motion of the two movable plates 25 in opposite directions. Additionally, since the rotating plate 26 rotates while the movable plates 25 moves horizontally, the first oblong hole 252 is designed with a certain degree of movable space to prevent mutual interference.

The drive block 27 is fixedly mounted on one of the movable plates 25. A strip-shaped slot 271 is opened at a side of the drive block 27 facing the base 21. An extension direction of the strip-shaped slot 271 is perpendicular to the movement direction of the movable plates 25 and parallel to an alignment direction of the two movable plates 25. The strip-shaped slot 271 has the same structure and function as the strip-shaped slot 141 of the first embodiment, which will not be repeated here.

The driven block 28 is fixedly arranged on the other movable plate 25. Two ends of the driven block 28 are also provided with oblong holes corresponding to the first oblong holes 252. The two connecting shafts 261 of the rotating plate 26 pass through the first oblong hole 252 and the oblong hole of the driven block 28.

The drive mechanism 29 has the same structure and function as the drive mechanism 15 in the first embodiment, so it is not repeated here.

The blade component 30 itself is a prior art, which includes a tool holder 31 mounted on the base 21, two first cutting mechanisms 32 mounted on the tool holder 31, and two second cutting mechanisms 33 mounted on the tool holder 31.

Four sliding grooves 311 is provided on the tool holder 31 so as to provide movement space for the drive rods 253. The drive rods 253 passes through the sliding grooves 311 and is inserted into either the first cutting mechanism 32 or the second cutting mechanism 33. The first cutting mechanism 32 and the second cutting mechanism 33 are configured for trimming beard or hair. The first cutting mechanism 32 may handle longer hair like beards, while the second cutting mechanism 33 may process shorter hair such as mustaches. Their structural design mirrors the blade component and cutting unit in the patent CN202322096770.8 titled "Hair Trimmer". The system operates by reciprocating the blade to cut hair between the moving blades and the stationary blades, which is a conventional technique that requires no further explanation. The reciprocating movement of the movable blades is achieved by the reciprocating movement of the driving rods 253. Specifically, the two driving rods 253 on one of the movable plates 25 are connected to one of the first cutting mechanism 32 and the second cutting mechanism 33, and the two driving rods 253 on the other movable plate 25 are connected to the other of the first cutting mechanism 32 and the second cutting mechanism 33, thereby allowing the movable plates 25 to drive the first cutting mechanisms 32 and the second cutting mechanisms 33.

Additionally, it should be understood that when the drive unit 20 includes two movable plates 25, and the two movable plates 25 may move simultaneously in same direction. The drive block 27 is fixed to the two movable plates 25, formed by direct injection molding of both the movable plates 25 and the drive block 27 without requiring the driven block 28. Consequently, the drive mechanism 29 synchronously actuates the two movable plates 25. Based on the explanation of the second embodiment above, those skilled in the art should be able to understand the working principle when the two movable plates 25 move in the same direction, so there is no additional diagram for explanation.

As described above, in the drive unit for hair trimmers, the movable plates 25 can move back and forth along the limit groove 241 of the limit pins 24 when driven by the driving motor 150 as the positioning groove 251 of the movable plates 25 is inserted into the limit groove 241 of the limit pins24. The contact between the positioning groove 251 and the side wall of the limit groove 241 in a direction perpendicular to the central axis of the limit groove 241 is line contact. Therefore, the clearance precision between the positioning groove 251and the limit groove 241 can be easily achieved and is less than 0.02mm. Therefore, in the moving direction of the movable plates 25, the arrangement direction of the central axes of the two limit pins 24 disposed in one of the movable plates 25 and that of the central axes of the other two limit pins 24 disposed in the other of the movable plates 25 may or may not be parallel, thus contributing to improving the product yield and reducing the production cost. In addition, the clearance precision between the movable plates 25 and the limit groove 241 in the thickness direction of the movable plate 25 can be easily achieved within 0.02mm by machining. Moreover, the two clearance precision are independent of each other, which making precision control straightforward. And it is also little affected by thermal expansion and contraction. It not only improves product yield and reduces costs, but also lowers the output power of the drive mechanism 150 due to minimal sliding resistance, thereby extending battery life.

While the disclosure has been described by way of example and in terms of exemplary embodiment, it is to be understood that the disclosures is not limited thereto. To the contrary, it is intended to lamp shade various modifications and similar arrangements (as would be apparent to those skilled in the art). Therefore, the scope of the appended claims should be accorded the broadest interpretation so as to encompass all such modifications and similar arrangements.

What is claimed is:

1. A drive unit for a hair trimmer comprising:
a cover plate (11, 22);
at least one pair of limit pins (12, 24) spaced apart each other and disposed on the cover plate (11, 22), each of the at least one pair of limit pins (12, 24) having a limit groove (121, 241) opened thereon;
at least one movable plate (13, 25) assembled on the at least one pair of limit pins (12, 24), two ends of each of the at least one movable plate (13, 25) having a positioning groove (131, 251), each of the positioning grooves (131, 251) being flexibly inserted into the limit grooves (121, 241) of the at least one pair of limit pins (12, 24), in a direction perpendicular to a central axes of the limit grooves (121, 241) a contact between a side wall of the positioning grooves (131, 251) and a side wall of the limit grooves (121, 241) being line contact; and
at least one drive block (14, 27) mounted on the at least one movable plate (13, 25).

2. The drive unit as claimed in claim 1, wherein the limit grooves (121, 241) are annular.

3. The drive unit as claimed in claim 1, wherein the positioning grooves (131, 251) are designed as a square groove.

4. The drive unit as claimed in claim 1, wherein the drive block (14, 27) comprises a strip-shaped slot (141, 271) opened in the at least one movable plate (13, 25), an extension direction of the strip-shaped slot (141, 271) is perpendicular to a moving direction of the at least one movable plate (13, 25).

5. The drive unit as claimed in claim 1, wherein the at least one movable plate (13, 25) is made of metal.

6. The drive unit as claimed in claim 1, wherein the at least one pair of limit pins (12, 24) is made of metal.

7. A hair trimmer having the drive unit as claimed in claim 1, comprising:
a base component (40); and
at least two drive units (20) disposed in the base component (40), the at least two drive units (20) comprising a drive mechanism (15, 29), the drive mechanism (15, 29) driving the at two least drive units (20) to move simultaneously in same direction.

8. The hair trimmer as claimed in claim 5, wherein the drive mechanism (15, 29) comprises a motor (150), and an eccentric shaft (151) disposed on the motor (150), the eccentric shaft (151) includes a central shaft section (152) and the eccentric section (153) connected to the central shaft section (152), the central shaft section (152) of the eccentric shaft 151 is coaxially aligned with the output end of the motor (150) and the eccentric section (153) is offset from the central shaft section (152).

9. A hair trimmer, comprising:
a base component (40); and
At least two drive units (20) disposed in the base component (40), the at least two driver units (20) comprising:
a cover plate (11, 22), the cover plate (22) having at least two fixing posts (222) spaced apart each other;
at least one pair of limit pins (12, 24) spaced apart each other and disposed on the cover plate (11, 12), each of the at least one pair of limit pins (12, 24) having a limit groove (121, 241) opened thereon;
at least one movable plate (13, 25) assembled on the at least one pair of limit pins (12, 24), two ends of each of the at least one movable plate (13, 25) having a positioning groove (131, 251), each of the positioning grooves (131, 251) being flexibly inserted into the limit grooves (121, 241) of the at least one pair of limit pins (12, 24), in a direction perpendicular to a central axes of the limit grooves (121, 241) a contact between a side wall of the positioning grooves (131, 251) and a side wall of the limit grooves (121, 241) being line contact, two first oblong holes (252) being respectively opened on two ends of each of the at least one movable plate (25), the first oblong holes (252) being positioned between the positioning groove (251) and a center of the movable plate (25);
at least two rotating plates (26) mounted on the cover plate (22), each of the at least two rotating plates (26) being rotatably arranged on the fixing posts (221), two ends of each of the at least two rotating plates (26) being respectively provided with the connecting shaft (261), the connecting shafts (261) being respectively inserted into one of the first oblong holes (252) of the two movable plates (25); and
at least one drive block (14, 27) mounted on the at least one movable plate (13, 25).

10. The hair trimmer as claimed in claim 9, wherein the drive unit (20) further comprises a driven block (28), the driven block (28) is mounted on the other movable plate (25).

11. The hair trimmer as claimed in claim 9, wherein the base component (40) comprises a handle (41) and a mounting base (42) mounted on the handle (41).
